(19) United States
(12) Patent Application Publication
(10) Pub. No.: US 2018/0309971 A1
(43) Pub. Date: Oct. 25, 2018

(54) SYSTEM DEVICE AND METHODS FOR GRADING DISCOMFORT EFFECTS OF THREE DIMENSIONAL (3D) CONTENT

(71) Applicant: 2Sens Ltd., Tel-Aviv (IL)

(72) Inventors: Moshe Meyassed, Kadima (IL); Osnat Goren-Peyser, Tel-Aviv (IL)

(21) Appl. No.: 15/956,908

(22) Filed: Apr. 19, 2018

Related U.S. Application Data
(60) Provisional application No. 62/486,990, filed on Apr. 19, 2017.

(51) Int. Cl. H04N 13/106; H04N 13/344

(52) U.S. Cl. CPC H04N 13/106; G06T 19/006; H04N 13/344

(57) ABSTRACT

A device system and methods comprising receiving a stereoscopic video or image of a scene including two perspective data streams (e.g. left and right) captured for example by a stereoscopic sensing device and analyzing the two perspective data streams based on predefined stereoscopic discomfort data and the depth map to yield one or more stereoscopic parameters; measure/process said stereoscopic parameters; assigning/calculating weight for one or more stereoscopic effects of said two perspective data streams of a scene according to the measured stereoscopic parameters; sum the weighted one or more stereoscopic effects to generate information of the impact of said one or more stereoscopic effects on a viewer of said 3D content.

### CROSS-REFERENCE

The present application claims the benefit of U.S. Provisional Application Ser. No. 62/486,990 filed on Apr. 19, 2017, entitled “Classification and grading of discomfort effects of 3D content in VR Headset” (attorney docket no. SE002/USP) which is incorporated herein by reference in its entirety.

### TECHNICAL FIELD

The present invention relates generally to stereoscopic content capturing and more particularly, to a device system and methods for analyzing the stereoscopic content to detect discomfort effects and grading the discomfort effects.

### BACKGROUND OF THE INVENTION

Prior to the background of the invention being set forth, it may be helpful to set forth definitions of certain terms that will be used hereinafter.

The term ‘stereoscopic artifacts’ or ‘discomfort effects’ or ‘stereoscopic effects’ as used herein are defined as one or more effects such as physiological effects or visual effects which might occur while watching a stereoscopic image or video, causing for example dizziness, nausea, eye-strain, etc.

The term ‘Virtual Reality’ (VR) as used herein is defined as a computer-generated environment that can generate physical presence in places in the real world or imagined worlds. Virtual reality could recreate sensory experiences, including virtual taste, sight, smell, sound, touch, and the like. Many traditional VR systems use a near eye display for presenting a 3D virtual environment.

The term ‘Augmented Reality’ (AR) as used herein is defined as a live direct or indirect view of a physical, real-world environment with elements that are augmented (or supplemented) by computer-generated sensory input such as video, graphics or GPS data. In some cases AR may be related mediated reality, in which a view of reality is modified (possibly even diminished rather than augmented), by a computer.

The term ‘near eye display’ as used herein is defined as a device which includes wearable projected displays, usually stereoscopic in the sense that each eye is presented with a slightly different field of view so as to create the 3D perception.

The term ‘virtual reality headset’ sometimes called ‘goggles’, is a wrap-around visual interface to display video or computer output. Commonly the computer display information is presented as a three-dimensional representation of real-world environments. The goggles may or may not include optics beyond the mere structure for holding the computer display (possibly in a form of a smartphone).

The use of stereoscopic 3D video photography in various fields is dramatically growing. Filmmakers, game developers as well as social mobile video platforms and live-streaming options on online video platforms, are all utilizing the visual benefits of stereoscopic 3D video photography over traditional two dimensional (2D) video. Accordingly, various technologies such as applications and systems for capturing and generating 3D stereoscopic video are developed to provide users with tools to create a stereoscopic 3D video.

Traditional three-dimensional image or video capture devices, such as digital cameras and video recorders include creating a 3D illusion by a pair of 2D images or videos. Stereoscopic 3D video provides more realistic experience but at the same time creates certain degree of discomfort to the viewer. Such visual discomfort effects are more severe when viewing 3D content using Head-Mounted Display (HMD) such as VR or AR headsets. Estimates of the number of people affected even after investing the efforts to reduce these visual discomfort effects vary between 14% and 50%. The amount and characteristics of physiological effects depend very much on the content being watched as well as on the sensitivity of the individual viewer.

### SUMMARY OF THE INVENTION

According to a first embodiment there is provided a method for identifying one or more stereoscopic effects in a three dimensional (3D) content having two perspective data streams of a scene captured by a stereoscopic camera, said stereoscopic camera comprising two cameras, the two cameras located at a distance from one another, and wherein the stereoscopic camera is configured to provide the two perspective data streams, the method comprising: providing a depth map of said scene based on the two perspective data streams; analyzing the two perspective data streams based on predefined stereoscopic discomfort data rules and the depth map to yield one or more stereoscopic parameters; measuring said stereoscopic parameters; identifying one or more stereoscopic effects based on said measured parameters.

In some cases the method can comprise assigning weight for the one or more stereoscopic effects of said two perspective data streams of the scene according to the measured stereoscopic parameters; summing the weighted one or more stereoscopic effects to generate information of the impact of said one or more stereoscopic effects on a viewer of said 3D content; determining the expected severity level of the one or more stereoscopic effects based on said information.

In some cases the one or more stereoscopic effects are weighted for each frame of said 3D content.

In some cases, the weight of said one or more stereoscopic effects are measured as a function of time for the complete 3D content.

In some cases, the information is presented on a display as a graph for each stereoscopic effect for the complete 3D content.

In some cases, the stereoscopic parameters are one or more of a motion or speed of one or more objects in the 3D content or the stereoscopic camera.

In some cases, the motion is one or more of: global motion, local motion, direction of motion (x, y, z subcomponents), gradient of motion, gradient of depth changes (z).

In some cases, the stereoscopic parameters are movements towards or away from the stereoscopic camera in the respective optical axis of one or more objects in the scene.

In some cases, the movements towards or away from the camera are detected by analyzing the rate of change in the depth map within consecutive frames of said two perspective data streams of a scene.

In some cases, the stereoscopic parameters are lack of synchronization between the left and right streams.

In some cases, the stereoscopic parameters are lack of calibration between the two cameras.

In some cases, the display is a virtual reality (VR) headset display or augmented reality (AR) display.

In some cases, the information is displayed in real time.

According to a second embodiment there is provided a device connectable to a portable computing platform having a processor, the device comprising: a stereoscopic camera comprising two cameras, the two cameras located at a distance from one another, wherein the stereoscopic camera is configured to provide a three dimensional (3D) content having two perspective data streams of a scene, and wherein the processor is configured to: provide a depth map of said scene based on the two perspective data streams; analyze the two perspective data streams based on predefined stereoscopic discomfort data rules and the depth map to yield one or more stereoscopic parameters; measure/process said stereoscopic parameters; identify one or more stereoscopic effects based on said processed parameters.

In some instances, the processor is configured to: assign weight for said one or more stereoscopic effects of said two perspective data streams according to the measured stereoscopic parameters; and sum the weighted one or more stereoscopic effects to generate information of the impact of said one or more stereoscopic effects on a viewer of said 3D content.

In some instances, the weight of said one or more stereoscopic effects are measured as a function of time or frame for the complete 3D content.

In some instances, the stereoscopic parameters are one or more of a motion or speed of one or more objects in the 3D content or the stereoscopic camera.

In some instances the motion is one or more of: global motion; local motion; direction of motion (x, y, z subcomponents); gradient of motion; gradient of depth changes (z).

In some instances, the stereoscopic parameters are movements towards or away from the stereoscopic camera in the respective optical axis of one or more objects in the scene.

According to a second embodiment there is provided a machine-readable non-transitory medium encoded with executable instructions for identifying and grading one or more stereoscopic effects in a captured stereoscopic image or video, the instructions comprising code for: providing a depth map of said scene based on the two perspective data streams; analyzing the two perspective data streams based on predefined stereoscopic discomfort data and the depth map to yield one or more stereoscopic parameters; measure said stereoscopic parameters; assign weight for the one or more stereoscopic effects of said two perspective data streams of a scene according to the measured stereoscopic parameters; sum the weighted one or more stereoscopic effects to generate information of the impact of said one or more stereoscopic effects on a viewer of said 3D content.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1A is a block diagram illustrating a system and methods for classifying and grading discomfort effects, in accordance with embodiments;

FIG. 1B shows a high level block diagram of the system and modules of FIG. 1A, in accordance with embodiments;

FIG. 2A illustrates a flowchart of method for classifying and/or grading stereoscopic effects in a captured stereoscopic image or video, in accordance with embodiments;

FIGS. 2B-2D show exemplary graph of the expected detected discomfort effects level as a function of frame or time of a captured 3D video, in accordance with embodiments;

FIG. 3 illustrates an example of method for detecting and grading stereoscopic effects such as dizziness, nausea, and eye stress in a captured stereoscopic image or video, in accordance with embodiments;

FIG. 4 is a block diagram of a system illustrating further details of the stereoscopic discomfort module, in accordance with embodiments; and

FIG. 5 is a flowchart illustrating a method for detecting and measuring an eye stress effect severity level in a 3D stereoscopic content, in accordance with embodiments.

### DETAILED DESCRIPTION OF THE INVENTION

As explained above, the present invention relates generally to stereoscopic video or image capturing and more particularly, to devices systems and methods for analyzing stereoscopic content to detect discomfort effects and grading the detected discomfort effects, for example for near-eye display such as VR or AR headsets.

As used herein like characters identify like elements.

The examples disclosed herein can be combined in one or more of many ways to provide improved stereoscopic effects detection and grading methods and devices.

Although we're witnessing some exciting leaps forward in the use of stereoscopic 3D for example for virtual reality and augmented reality use, some regression is still accruing as the human body is still adjusting to these types of immersive experiences. Often as we strap on a VR headset or some AR glasses for an extended period of time, we start to feel some discomfort such as strain on our eyes, dizziness etc. As a result some 3D VR or AR headset users will hopelessly stop watching the 3D content following a short viewing period.

Stereoscopic 3D video implies that each eye of the viewer sees the 3D video from a different angle. The Stereoscopic 3D video is typically captured with two cameras that are placed with a baseline distance between them. In many cases this distance is −65 mm which is the average distance between the eyes, but this distance can also vary.

As part of a stereoscopic 3D viewing experience including using an HMD such as a VR or AR headset the left eye sees content recorded by the left camera while the right eye sees content recorded by right camera. Inside the VR headset the left and right captured content covers a very large field of view and hence the viewer is more affected by the 3D discomfort phenomena.

The physiological effects created by viewing a stereoscopic 3D content include for example: dizziness, disorientation; motion sickness (e.g. Sea sickness); eye-stress or eye fatigue and other known effects.

There is a need for improved methods and systems for identifying, measuring, classifying and grading one or more discomfort effects, such as visual discomfort effects of a 3D stereoscopic content caused while watching the stereoscopic content, for example while using an HMD and displaying the grading results to the viewer.

In accordance with embodiments there are provided systems devices and methods for analyzing a stereoscopic 3D content, including for example stereoscopic 3D video or images, to detect one or more discomfort effects such as physiological effects in the stereoscopic 3D content.

The devices systems and methods, in accordance with embodiments, are configured to receive a 3D content including a side by side movie or two separate movies. Specifically the 3D content includes a stereoscopic video or image of a scene including two perspective data streams (e.g. left and right) captured for example by a stereoscopic sensing device and analyze the received stereoscopic video or image using computer vision techniques to extract one or more parameters such as depth and motion information to detect discomfort effects (e.g. physiological effects).

According to some embodiments the discomfort effects may be one or more of the following effects: dizziness, nausea, disorientation, motion sickness, sea sickness and eye stress (for example resulted due to vergence-accommodation conflict and/or due to mismatch between the left and right streams and/or vertical alignment and/or Field-of-View, Timing etc.) imposed on the content viewer and estimate the expected severity level of each of the detected effects.

In some embodiments the detection further includes classifying and grading the detected discomfort effects for example based on physiological effects imposed on the 3D content viewer.

In some embodiments, the detection includes creating a weighted average of the effects to provide an overall grade for the comfort or discomfort level of the 3D content.

In some embodiments, the analysis includes analyzing frame by frame the captured 3D content to detect one or more parameters which relate to expected discomfort effects over time, such as a user's movement direction over time, process the detected parameters and measure the expected severity level for classifying or grading the discomfort effects.

According to some embodiments, a threshold level may be set automatically or manually by the user for one or more selected effects and farms which exceed the thresholds are marked.

According to some embodiments, the detection includes analyzing the captured video to detect whether the movement is caused by the stereoscopic camera or if it is caused by one or more captured objects in the scene moving fast. In some cases, detecting fast movement of the camera from the content is based on global motion measurements, while detection of fast movement of objects within the content is based on local motion detection.

According to some embodiments, there are provided systems and methods for detecting cause of nausea in a captured stereoscopic video of a scene and measure the expected severity level of the detected nausea. Specifically, the system and method comprise detecting a fast vertical movement which causes nausea frame by frame. The detection includes analyzing the captured stereoscopic video to detect whether the movement is caused by the stereoscopic camera or if it is caused by one or more captured objects in the scene moving fast. In some cases, the system and methods include detecting a stereoscopic camera vertical movement for example based on camera position in the frames and object position and movement are calculated from scene depth map and extracting it from the camera global motion.

According to some embodiments, there are provided systems and methods for detecting vergence—accommodation conflict effect which causes eye stress while viewing the captured stereoscopic video of a scene and measure the expected severity level of the detected vergence—accommodation conflict. Specifically, the system and method comprises detecting the distance of a nearest object in the captured scene from the stereoscopic camera. The detection includes analyzing the captured video to detect if the movement is caused by the stereoscopic camera or if it is caused by one or more captured objects in the scene moving fast.

With specific reference now to the drawings in detail, it is stressed that the particulars shown are by way of example and for purposes of illustrative discussion of the preferred embodiments of the present technique only, and are presented in the cause of providing what is believed to be the most useful and readily understood description of the principles and conceptual aspects of the present technique. In this regard, no attempt is made to show structural details of the present technique in more detail than is necessary for a fundamental understanding of the present technique, the description taken with the drawings making apparent to those skilled in the art how the several forms of the invention may be embodied in practice.

Before at least one embodiment of the present technique is explained in detail, it is to be understood that the invention is not limited in its application to the details of construction and the arrangement of the components set forth in the following description or illustrated in the drawings. The present technique is applicable to other embodiments or of being practiced or carried out in various ways. Also, it is to be understood that the phraseology and terminology employed herein is for the purpose of description and should not be regarded as limiting.

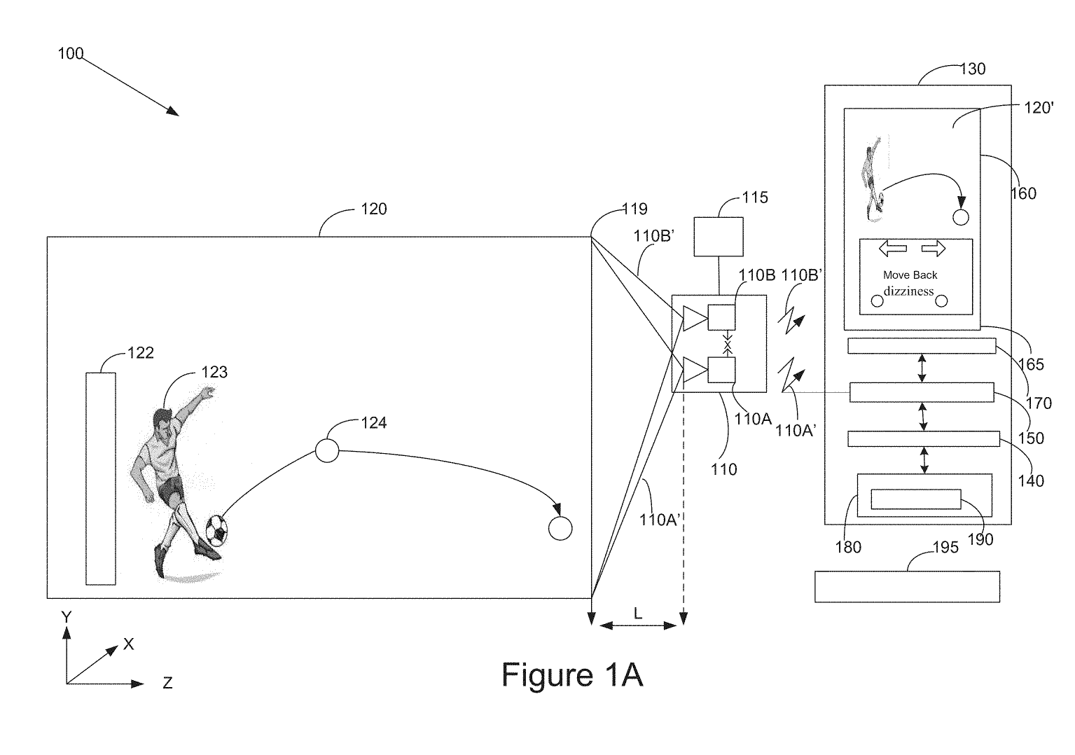

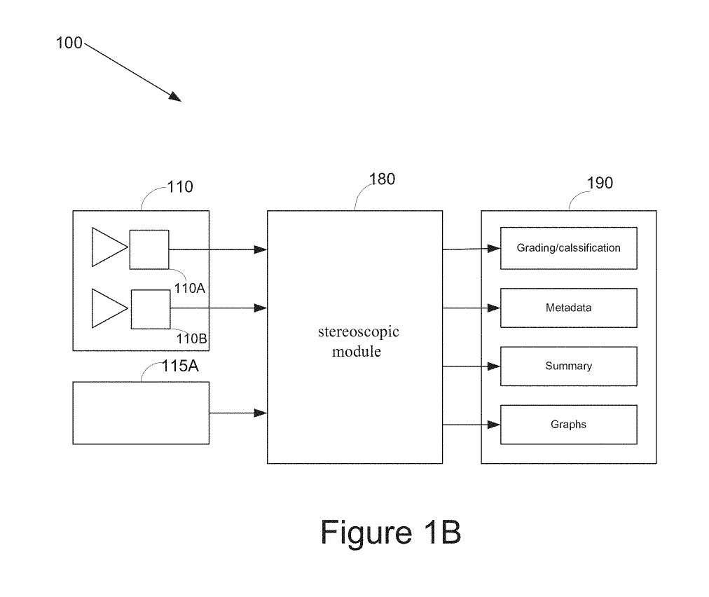

FIG. 1A is a block diagram illustrating an example of system 100 for analyzing a 3D stereoscopic video of a scene 120 captured for example by a stereoscopic sensing device 110 (e.g. stereoscopic camera) to identify one or more stereoscopic effects in the captured video and estimating (e.g. grading) the expected severity level of each of the identified effects, in accordance with embodiments. The stereoscopic sensing device 110 includes two sensors such as respective cameras 110A and 110B either fixed or configured to move to achieve convergence. In some cases, the cameras 110A and 120B may be RGB or monochrome cameras,

In some cases, each camera comprises lens which may form an image on a light sensitive sensor such as a CCD array. The sensing device 110 is configured to move in space for capturing stereoscopic images or videos of the scene 120 from all possible angles.

According to embodiments, camera 110A provides captured data such as video streams (e.g. RGB streams) of the left perspective viewpoint 110A′ of the scene 120 and camera 110B provides captured data such as video streams (e.g. RGB streams) of the right perspective viewpoint 110B′ of the scene 120. The camera lenses are separated by distance X and the distance from the cameras, or their lenses, to the plane of convergence, in the visual world is given by distance L. The two cameras' fields of view coincide on rectangular area 119, with the axes of the two lenses crossing at the intersection of lines X and Y of axis X-Y-Z. An object intersecting plane 119 will be imaged to appear in the plane of the display screen, such as a near eye display 195.

According to some embodiments, the sensing device 110 may include or may be in communication with device 130 which may comprise, for example, desktop, laptop, or tablet computers, media consoles, personal digital assistants or smart phones, or any other sort of device which may be for example connectable to the network, and comprises video and audio interfaces and computing capabilities needed to interact with sensing device 110 for example wirelessly or via a wire connection (e.g. via ports such as USB ports). By way of example, device 130 may comprise a computer with one or more processing units 140, memory 150, video display 160 and speakers 170 for playing and displaying captured stereoscopic video 120′ of the captured scene 120, along with another video camera and microphone.

According to some embodiments the system may include an HMD 195 such as a virtual reality (VR) or AR headset (goggles), such as a VR HMD, AR glasses, 3D TV, 3D cinema or a near eye display configured to project a synthetic 3D scene and interface with a mobile device 130. Devices 110 and 130 are further configured to physically and electronically interface with the near eye display 195 that form together the VR or AR headset. Such a VR headset (goggles) may be arranged for use with smartphones, as is known in the art, and usually includes optics which can transmit the display of the smartphone, a sleeve for accommodating smartphone and a strap for fastening the VR headset (goggles) onto the head of the user. It is understood however that devices 110 and 130 may interface with near eye displays such as Samsung Gear VR™ and Oculus Rift™. Ergonomically, some embodiments of the present invention eliminate the need for a VR specific device and will further save costs.

In some embodiments the system 100 may further comprise one or more measurement units 115 such as Inertial Measurement Units (IMU) configured to detect and provide measurements data relating to the sensing device, including for example the sensing device 110 or device 130 linear acceleration and rotational rate using one or more accelerometers and one or more gyroscopes.

According to some embodiments, the system 100 comprises a stereoscopic grading module 180 which comprises for example a stereoscopic discomfort data 190 including information on discomfort stereoscopic effects. In some cases, stereoscopic discomfort data 190 includes, metadata, summary and information such as location or specific settings of sensors or cameras. In some cases, the stereoscopic grading module 180 may be executable by one or more processors such as the processing units 140. Specifically, in accordance with embodiments, the stereoscopic grading module 180 is configured to receive the two perspective data streams 110A′ and 110B′ of the captured scene and analyze, for example each of the two perspective data streams for example frame by frame based on predefined data including stereoscopic discomfort rules, stored for example in the device's memory storage 150 and executable by the processor and a depth map of the scene 120 based on the two perspective data streams 110A and 110B to yield one or more stereoscopic parameters. The parameters are processed (e.g. measured and/or calculated) to generate and a stereoscopic discomfort data 190 including for example grading results which include a general estimation of the expected severity level of the analyzed stereoscopic effects and/or a grading for each detected stereoscopic effect.

In some aspects, the modules, such as the stereoscopic grading module 180 may be implemented in software (e.g., subroutines and code). In some aspects, some or all of the modules may be implemented in hardware (e.g., an Application Specific Integrated Circuit (ASIC)), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

Optionally, the modules such as the stereoscopic grading module 180 can be integrated into one or more cloud based servers.

According to some embodiments, as illustrated in FIG. 1A the scene 120 may include static objects and moving objects which continually move, roam and shake in space in respect to the 3-dimensional coordinate system (X-Y-Z) while the sensing device 110 may accordingly move in space and capture in real time a stereoscopic image or video of the scene from all possible angles and locations. In accordance with embodiments, there are provided methods and systems for capturing a stereoscopic image or video of the scene 120 or receiving a stereoscopic image or video captured by other devices (e.g. via the web) and analyzing the captured image or video to detect, for example in real time, whether the cause of discomfort effects or artifacts such as dizziness, nausea, eye-strain (or other visual discomforts) in the captured stereoscopic video or image results from the location and/or speed of the sensing device 110 in respect to objects in the captured scene and/or the location or speed of captured objects in respect to the sensing device.

The system and methods further include presenting the type of the caused effect and a grade for each caused effect or a total grade for all detected stereoscopic effects in the form of visual and/or voice marks, such as text and/or icons displayed on the screen of device 130 for updating the user for example prior to the user's viewing the video the expected discomfort level that he will experience when viewing the 3D video.

FIG. 1A illustrates an example of the scene 120 presenting a football stadium including one or more static elements such as football balcony, football field and goalpost 122 as well as moving elements and objects such as a football player 123 and ball 124. In accordance with embodiments, the stereoscopic module 180 is configured to analyze the captured stereoscopic video 120′ of the captured scene 120 and detect one or more effects such as physiological effects resulted for example from the movement, pose and speed, such as horizontal movements (e.g. panning) or vertical movements of objects in the scene 120, for example the football player 123 and/or the ball 124 in respect to the movement, pose and speed of the sensing device 110 and vice versa. As explained above, the system is configured to measure the expected severity level of each of the detected effects according to the type of caused discomfort and may provide a grade for each of the identified effects. For example, the module 180 may detect that the kicked ball 124 in the captured 3D video 120′ flies too close to the sensing device or the sensing device is moved to close to the captured scene and will therefore cause “dizziness” to the viewer. The detected “dizziness” is analyzed to estimate it's severity level (‘high’, ‘low’, average or in numbers from ‘1’ (e.g. low) to ‘10’ (e.g. high)). The grade may be further displayed on a display unit such as display 160, for example in real time.

FIG. 1B shows a high level block diagram of the system 100, in accordance with embodiments. The data streams (e.g. left and right) of cameras 110A and 110B are transmitted to the stereoscopic module 180 configured to analyze and synchronize, for example in real-time, the data streams. Optionally or in combination, the data streams and measurements data of the measurement unit are transmitted to the stereoscopic module 180 for time synchronizing the data streams with a measurements data to yield for example a location and/or time stamp for each frame of the left and right data streams.

According to some embodiments, following the synchronization and analysis of the data streams the stereoscopic discomfort module 180 is configured to yield a stereoscopic discomfort data 190 including for example, grading or classification for each identified stereoscopic effect; metadata on the discomfort grading level; summary, graphs etc.

In some cases, the data 190 may be presented on a display, such as a 3D near eye display for updating the viewer prior to or in in real-time while viewing the 3D video.

According to some embodiments the data 190 (e.g. the grading) may be displayed in the form of text and/or voice and/or one or more icons.

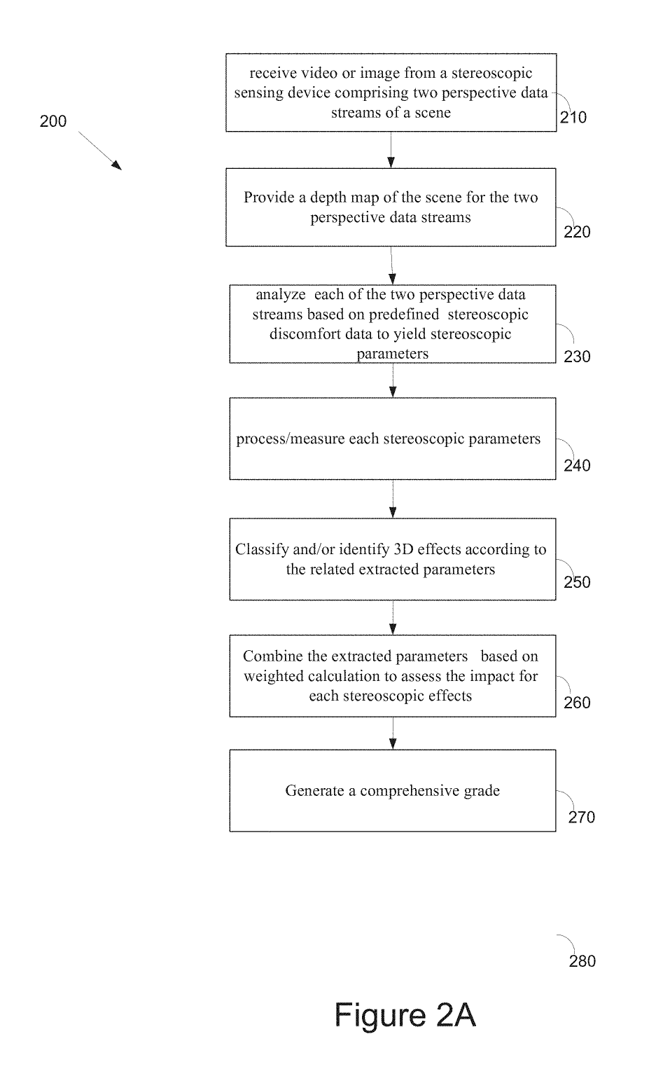

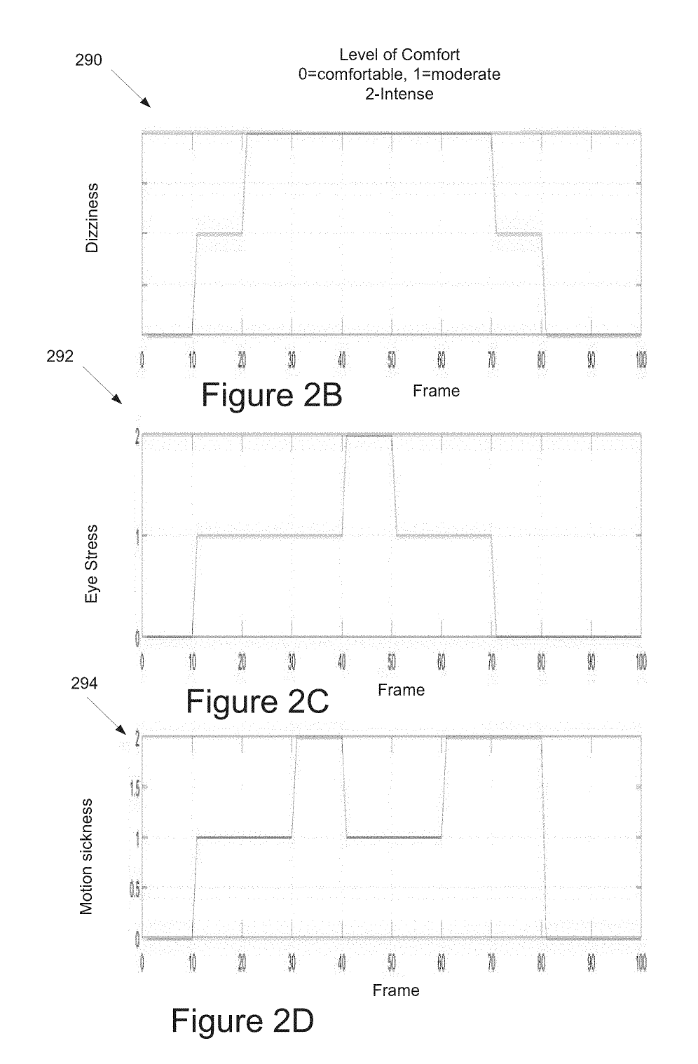

FIG. 2A illustrates a flowchart of method 200 for detecting and grading stereoscopic effects such as discomfort artifacts in a captured stereoscopic image or video of a scene, in accordance with embodiments. System 100, for example, may be used to implement method 200. However, method 200 may also be implemented by systems having other configurations. At step 210 a stereoscopic 3D content such as video 120′ or image of the scene 120 as captured for example by the stereoscopic sensing device 110 may be received for example at device 130. The video 120′ comprises two perspective data streams of the scene 120. In some cases, the video 120′ may be displayed for example on the display 160 (e.g. preview display) of device 130 to allow the user to visualize what image can be currently captured.

At step 220 a depth map and motion analysis of the captured scene is provided, for example by the stereoscopic module 180 for the two perspective data streams.

At step 230 each of the two perspective data streams are analyzed, and compared to predefined stereoscopic discomfort data rules/scale by using also the depth map of for example both perspective data streams to extract one or more stereoscopic parameters.

In some cases the predefined stereoscopic discomfort data rules comprise one or more parameters related to the cause of dizziness, nausea, eye stress and the like in a captured stereoscopic image of video. Non-limiting examples of such parameters include: gap between the stereoscopic camera and captured targets, camera velocity, target velocity, motion and/or depth of objects or the camera.

According to some embodiments the analysis includes analyzing frame by frame each video using computer vision techniques. According to some embodiments, the extracted parameters include motion of objects in the captured scene or the camera (local motion), motion of the entire scene (global motion, result of movement of the camera); direction of motion (x, y, z subcomponents), gradient of motion, gradient of depth changes (z) and more.

At step 240 each extracted parameter are processed. The processing includes measuring each parameter. The result is the magnitude of each parameter, per point of time in the stereoscopic video, which is later used to estimate the severity of the expected discomfort.

At step 250 the parameters are used to identify and/or classify one or more related stereoscopic effect (e.g. dizziness, eye stress, motion thickness etc.)

At step 260 the extracted parameters are combined based on the weighted calculation to assess and grade the impact of each of the stereoscopic effects on the viewer. For example, even if the measured parameters indicate low level of dizziness, if eye-stress level is relatively high and last for relatively long duration, the overall discomfort level will reach high values. In some cases, one or more selected effects may have more significant in the combined calculation than other effects. For example eye stress effect may receive higher weight than nausea effect in the combined calculation.

According to some embodiments, one or more thresholds levels may be set automatically for example by the processor (e.g. default option) or manually by the user for one or more selected effects and farms which exceed the thresholds are marked. In some cases, the automatic thresholds are based on average people's reaction to the effect. A very sensitive user can manually lower the threshold and an extreme user can increase the threshold manually.

In some cases at step 270 a comprehensive grade, which is a composition of all physiological effects, is generated as function of time in the movie. The composition takes into account extreme cases of single physiological effect as well as superposition of all effects

For example, the severity of dizziness that the viewer will experience is a function of motion (global vs local), direction of motion (x, y, z subcomponents), gradient of motion and gradient of depth changes (z). By running analysis on the 3D video, all these parameters are extracted frame by frame along the entire video. Then, the expected physiological effect of dizziness is calculated and may be presented as a function of frame (time) in the movie.

Another example includes measuring the severity level of eye-stress and eye-fatigue which may result of a mismatch between the left and right streams. This include mismatch in vertical alignment/vertical field-of-view, mismatch of optical axes, mismatch in timing/synchronization, and more. Such mismatches creates “ghosting effects” and accumulative eye-stress.

In some cases the analysis may include detecting a peak value (e.g. maximum instantaneous value) of each effect in the movie as well as the peak value of the superposition of the effects and declaring this as the worse level of the movie.

In some cases the analysis may include measuring time-average of the value of each effect along the movie, and then superposition average value of each effect, and declaring this as the average comfort level of the movie.

In some cases the analysis and grading is performed in Real-Time while capturing the stereoscopic content itself. For example while viewing a 3D content using an HMD the results (e.g. effect indication and/or grading) may be displayed in real time for each viewed frame.

FIG. 2B shows an exemplary graph 290 presenting the expected dizziness level as a function of frame or time of a captured 3D video, suitable for incorporation in accordance with embodiments. The graph 290 presents for each frame 0-100 in the captured video the measured dizziness level. The measured dizziness level is based on the aggregated weighted parameters extracted for each analyzed frame.

FIG. 2C shows an exemplary graph 292 presenting the expected eye-stress level as a function of frame or time of a captured 3D video, suitable for incorporation in accordance with embodiments. The graph 292 presents for each frame 0-100 in the captured video the measured eye-stress level. The measured eye-stress level is based on the aggregated weighted parameters extracted for each analyzed frame.

FIG. 2D shows an exemplary graph 294 presenting the expected motion sickness level as a function of frame (e.g. time) of a captured 3D video, suitable for incorporation in accordance with embodiments. The graph 294 presents for each frame 0-100 in the captured video the measured motion sickness level. The measured motion sickness level is based on the aggregated weighted parameters extracted for each analyzed frame.

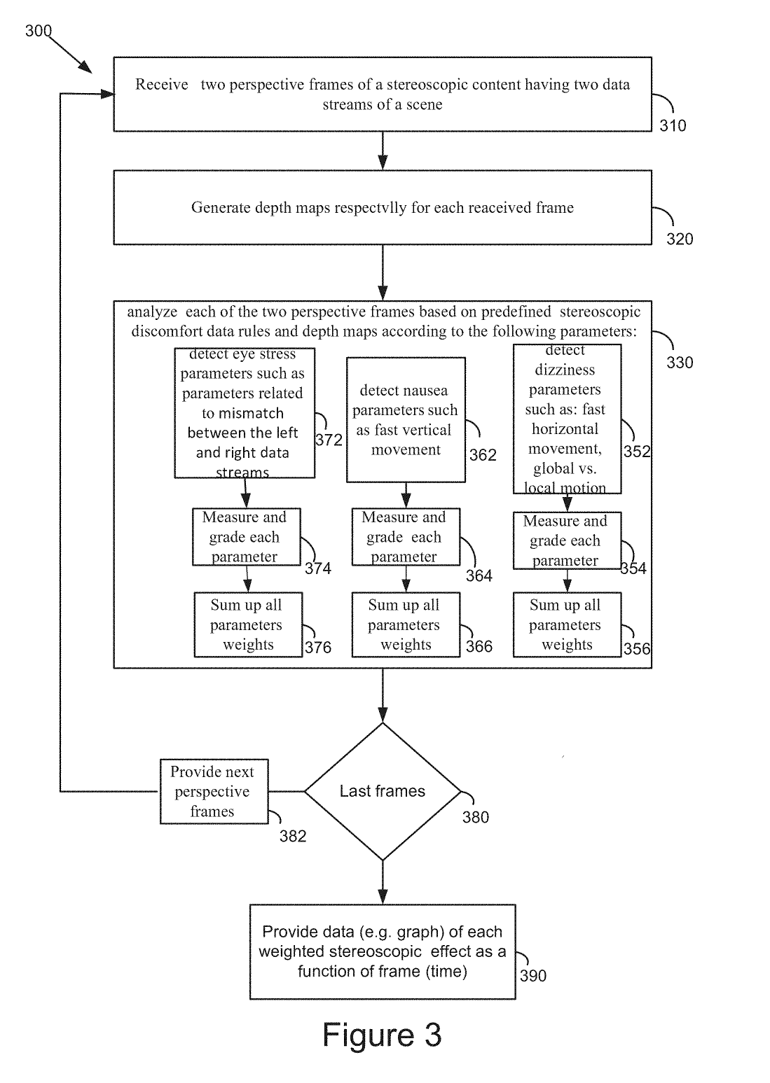

FIG. 3 illustrates an example of an analysis method 300 for ranking the stereoscopic visual quality of a stereoscopic 3D contact by estimating the level such as severity level of one or more visual discomfort effects such as dizziness, nausea, and eye stress on the 3D content viewer, in accordance with embodiments. System 100, for example, may be used to implement method 300. However, method 300 may also be implemented by systems or devices having other configurations, for example via a processing module at a remote server. At step 310 the device 130 receives two perspective frames (e.g. the first two perspective frames) of a stereoscopic content for example video 120′ or image of scene 120 as captured, for example by the stereoscopic sensing device 110. The video 120′ comprises two perspective data streams of the scene 120. In some cases, the video 120′ may be displayed for example on the display 160 (e.g. preview display) of device 130 to allow the user to visualize what image can be currently captured. At step 320 depths map are generated for example for each respective frame. At step 330 an analysis process is initiated for example by one or more processors. At the followings steps each of the two perspective frames are analyzed, for example simultaneously, to estimate the severity level (e.g. discomfort level) and/or classify of one or more visual stereoscopic effects by extracting one or more stereoscopic parameters related to the stereoscopic effects. Specifically, at step 352, for each two frames (e.g. left and right), parameters related to a dizziness effects in a 3D video are extracted. For example the detected parameters may be fast horizontal movement such as global motion vs. local motion etc. At step 354 each of the extracted parameters are measured and graded. At step 356 the measured parameters are summed to determine the severity level (e.g. discomfort effect level) of the dizziness effect for the analyzed frames.

According to some embodiments, the processor may further analyze for each received two frames (e.g. left and right), based on predefined stereoscopic discomfort data stored for example in memory storing instructions executable by the processor may detect at step 362 one or more stereoscopic parameters related to nausea effect such as fast vertical movement. At step 364 the detected parameters are measured and graded and at step 366 the detected parameters are summed to determine the severity level (discomfort effect level) of the nausea effect for the analyzed frames.

According to some embodiments, the processor may further analyze for each received two frames (left and right), based on predefined stereoscopic discomfort data stored for example in memory storing instructions executable by the processor and/or depth maps and detect at step 372 one or more stereoscopic parameters related to eye stress effects. The detected parameters may include parameters related to mismatch between the left and right analyzed frames. In some cases the detection includes analyzing the captured stereoscopic video to detect a distance of a nearest object in the captured scene from the stereoscopic sensing device. At step 374 each detected parameters are measured and graded and as step 376 the detected parameters are summed to determine the severity level (discomfort effect level) of the eye stress effect for the analyzed frames.

At step 380 the frames index number is checked. If the two frames are not the last frames then at step 382 the next perspective frames in the 3D video are provided and received at step 310 for further analysis. If these are the last frames than at step 390 the data is summed and/or processed and provided for example as graph presenting for each stereoscopic effect a grade as a function of frame and/or time.

In some cases, the data is further processed to generate general and detailed information on discomfort effects identified at the analyzed 3D video.

In some cases, the parameters detection steps, such as movement detection includes analyzing the captured video to detect if the movement is caused by the stereoscopic camera and therefore will cause dizziness and/or motion sickness or if it is caused by one or more captured objects in the scene moving fast towards the camera and therefore will create eye-stress.

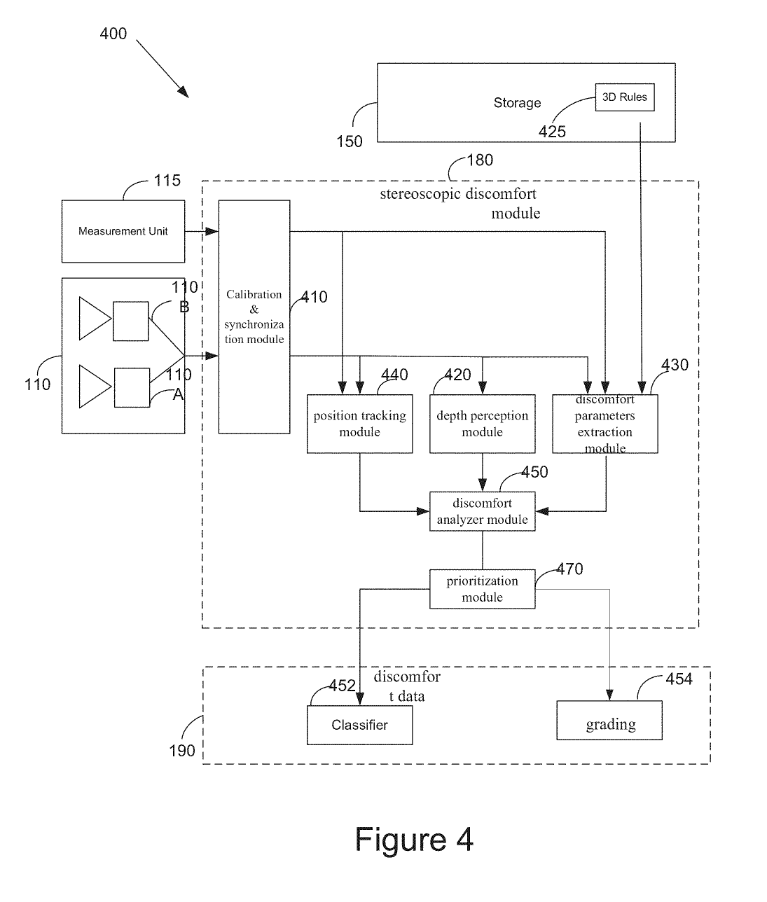

FIG. 4 is a block diagram of a system 400 illustrating further details of the stereoscopic module 180, in accordance with embodiments. The module 180 may comprise a calibration and synchronization module 410 configured to receive the left and right data streams from cameras 110A and 110B and accordingly time synchronize the data streams.

Additionally the calibration and synchronization module 410 is configured to perform optical adjustments between the received left and right data streams such that the output of the left and right data streams as will be projected on the 3D display are optically synchronized. The optical adjustments may include for example brightness and/or contrast and/or sharpness, and/or color and/or focus area adjustments between the data streams. In some cases, the optical adjustments may further include specific optical adjustments to in scene objects such as size adjustments (FOV correction) etc.

According to some embodiments the calibration and synchronization module 410 is further configured to geometrically calibrate the received left and right data streams such that that objects will appear in the same size and in the same video line numbers at the same frame.

According to some embodiments, the calibrated and synchronized data streams are transmitted to a depth perception module 420 for processing the calibrated and synchronized data streams and generating a depth map of the captured scene. The depth map may include 3D data such as the size and distance of in-scene detected objects from the sensing device 110, for example per each frame or substantially per each frame.

According to some embodiments, the calibrated and synchronized data streams are transmitted to a discomfort parameters extraction module 430 for processing the calibrated and synchronized data streams and providing one or more discomfort parameters indicators defining for example for one or more frames (e.g. for each frame) whether the received processed data streams (e.g. left and right) are in line with predefined stereoscopic discomfort data rules 425 (e.g. 3D video photography rules) to classify and grade artifacts such as stereoscopic artifacts such as dizziness, nausea, eye stress etc. The predefined stereoscopic discomfort data rules include for example: maximum speed of objects in pixels/frame relative to its size in pixels and are extracted by analyzing for example the sensor resolution, light conditions and focus condition as captured by the sensor.

In some cases, predefined stereoscopic discomfort data rules 425 may be predefined 3D video photography rules stored for example at memory storage 150.

According to some embodiments, the calibrated and synchronized data streams are transmitted to a position tracking module 440 configured to track and find the position of the stereoscopic sensing device 230 in space in respect to, for example the sensing device 110 or the user. For example, the position tracking module 440 may analyze each frame of the synchronized data streams and extract the location of the sensing device 130.

Alternatively or in combination, the position tracking module 440 may receive location measurement data including for example the sensing device position in space as measured for example by the one or more measurement units 115 (e.g. IMU) and process the received location measurement data (e.g. IMU parameters) with the video data streams to yield for each frame the location (position and orientation) of the sensing device 110. In some cases the sensing device 110 location in space may include the sensing device location in six degrees of freedom (6DoF) per frame.

In accordance with embodiments, the system 400 further comprises a discomfort analyzer module 450 configured to receive and process the depth map of the captured scene, the measured position of the sensing device and discomfort parameters to yield stereoscopic discomfort data 190. Non-limiting examples of parameters analyzed and detected by module 450 include parameters related to the scene such as: relative size of an object; distance of objects from camera; location of objects in the frame; depth movements. Additionally the parameters include camera related parameters such as: stability; panning movement; up and down movement; in depth movements.

According to some embodiments, the stereoscopic discomfort data 190 comprises one or more classifiers 452 to provide the user with information of the detected effects

According to some embodiments the stereoscopic discomfort data 190 is configured to provide grading 454 including for example a total comfort viewing grade of the captured 3D video, or specific grades for each identified stereoscopic discomfort effect.

In some cases, the total comfort viewing grading may be presented numerically or in other form. For example a high rank (e.g. ‘100’ or ‘A’) for a resulted professional 3D video and low rank (‘0’ or ‘D’) for a poorly captured stereoscopic video which as result of not following the 3D imaging guidelines may not be displayed. The 454 may be added to the 3D imaged video in an MP4 format or any known in the art video format. In some cases the metadata may be stored in a local database or external database such as a local cloud

According to some embodiments the comfort grading results 454 may be presented for each captured stereoscopic frame or for a set of captured stereoscopic video frames, for example to a set of sequential captured video frames. The grading results indicate the comfort and/or discomfort level of each or a plurality of captured stereoscopic frames. In some cases the comfort grading results 454 may include a detailed report including for example detailed comfort grading results. In some cases the comfort grading results 456 may include a summary status for each frame indicating the comfort level of each captured frame, for example in text format such as ‘low’-indicating the captured frame includes discomfort artifacts, or ‘high’ indicating the captured frame doesn't include any discomfort artifacts. In some cases the grading may be presented in the form of for example one or more graphs as illustrated in FIG. 2B-2D.

According to some embodiments, the module 180 may include a prioritization module 470 configured to prioritize if and which discomfort effect to be notified the user. For example the prioritization module 470 may receive the depth map of the captured scene, the measured position of the sensing device and discomfort parameters and rank one or more frames (e.g. all frames) based on the type of discomfort effect and the discomfort level. For example dizziness effects will gain high grade while eye-strain effect will gain low grade, therefore some eye strain effects included in a number of frames will not be notified to the user while small dizziness effects will be notified.

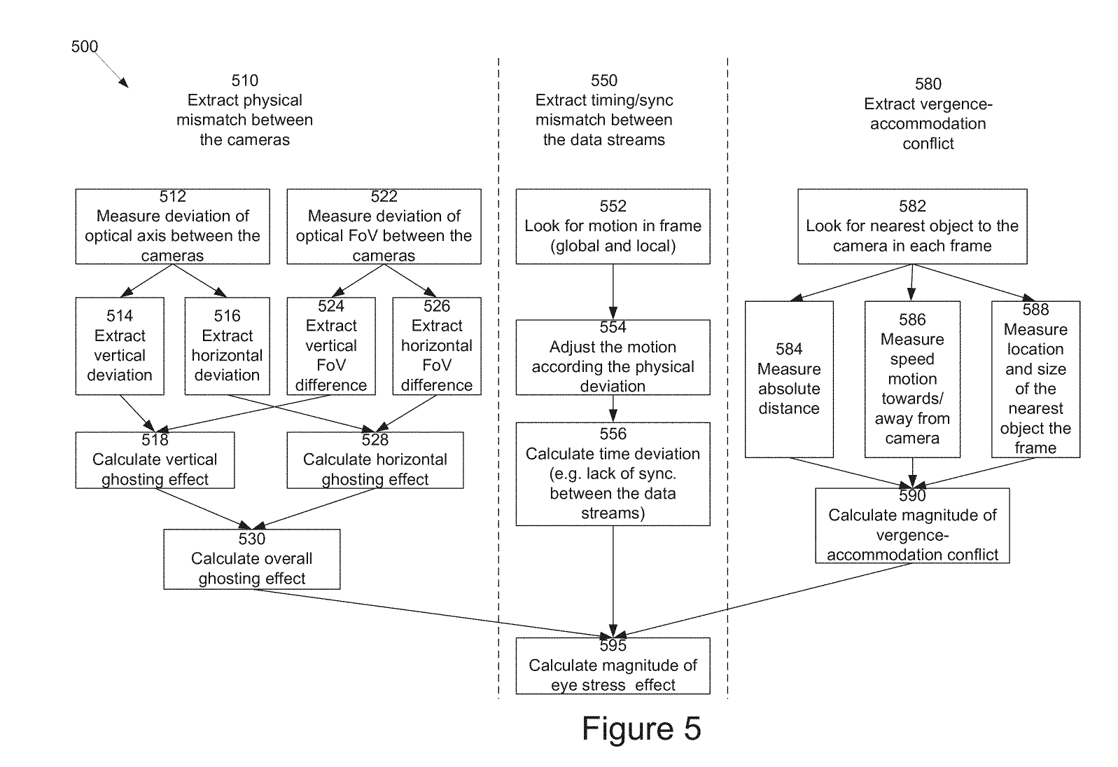

FIG. 5 is a flowchart illustrating a method 500 for detecting and measuring an eye stress effect severity level in a 3D stereoscopic content (e.g. 3D video), in accordance with embodiments. In some cases, the method 500 further includes classifying and measuring the eye stress magnitude for each frame and/or the complete 3D video. The method 500 includes three processes 510, 550, 580 for analyzing the 3D video frames to extract the following stereoscopic parameters: physical mismatch between the stereoscopic cameras 510; timing/sync of mismatch between the data streams 550; and vergence-accommodation conflict 580. In some cases, the three process may be performed concurrently or successively for each frame of the 3D video, for example in real time.

The process of extracting physical mismatch between the cameras 510 includes at step 512 measuring a deviation of the optical axis between the stereoscopic cameras (e.g. cameras 110A and 110B), which includes extracting at step 514 a vertical deviation and at step 516 extracting a horizontal deviation.

The process of extracting physical mismatch between the cameras 510 further includes at step 522 measuring the deviation of optical Field of View (FoV) between the two stereoscopic cameras, which includes at step 524 extracting a Vertical FoV difference and at step 526 a horizontal FoV difference. The extracted vertical deviation and vertical FoV difference are used to calculate at step 518 a vertical ghosting effect parameter, while the extracted horizontal FOV difference and horizontal deviation are used to calculate at step 528 a horizontal ghosting effect parameter. The calculated horizontal ghosting effect parameter and vertical ghosting effect parameter are further used at step 530 to calculate an overall ghosting effect parameter.

The process of extracting timing/sync of mismatch parameters between the data streams 550 includes at step 552 searching for one or more motions in the frames, such as global and local motions. At step 554 the detected motions are adjusted according physical deviation that was measured in process 510 and at step 556 a time deviation (e.g. lack of sync between the two data streams) is calculated.

The process of extracting vergence-accommodation conflict 580 includes at step 582 searching for the nearest object in the video frames (e.g. for each frame) to the camera (e.g. such as camera 110). At step 584 the absolute distance of the nearest object from the camera is measured, at step 586 the speed motion towards/away from the camera is measured and at step 588 the location and/or size of the detected nearest object at each frames is measured. At step 590 the measured absolute distance, speed motion, location and size are used to calculate the vergence-accommodation conflict parameter.

The calculated vergence-accommodation conflict parameter, overall ghosting effect parameter and time deviation parameter are used at step 595 to calculate the eye stress effect magnitude for each frame, or for selected frames or all frames of the 3D video.

In some cases, all three processes 510, 550, 580 are used for analyzing the 3D video frames to extract the stereoscopic parameters. In some cases only one or two of the three process are used.

In further embodiments, the processing unit may be a digital processing device including one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the system disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device.

In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media. In some embodiments, the system disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof. In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, the system disclosed herein includes software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the system disclosed herein includes one or more databases, or use of the same. In view of the disclosure provided herein, those of skill in the art will recognize that many databases are suitable for storage and retrieval of information as described herein. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for identifying one or more stereoscopic effects in a three dimensional (3D) content having two perspective data streams of a scene captured by a stereoscopic camera, said stereoscopic camera comprising two cameras, the two cameras located at a distance from one another, and wherein the stereoscopic camera is configured to provide the two perspective data streams, the method comprising:
providing a depth map of said scene based on the two perspective data streams;
analyzing the two perspective data streams based on predefined stereoscopic discomfort data rules and the depth map to yield one or more stereoscopic parameters;
measuring said stereoscopic parameters;
identifying one or more stereoscopic effects based on said measured parameters.

2. The method of claim 1 comprising:
assigning weight for the one or more stereoscopic effects of said two perspective data streams of the scene according to the measured stereoscopic parameters;
summing the weighted one or more stereoscopic effects to generate information of the impact of said one or more stereoscopic effects on a viewer of said 3D content;
determining the expected severity level of the one or more stereoscopic effects based on said information.

3. The method of claim 2 wherein the one or more stereoscopic effects are weighted for each frame of said 3D content.

4. The device of claim 2 wherein the weight of said one or more stereoscopic effects are measured as a function of time for the complete 3D content.

5. The method of claim 2 wherein said information is presented on a display as a graph for each stereoscopic effect for the complete 3D content.

6. The method of claim 1 wherein said stereoscopic parameters are one or more of a motion or speed of one or more objects in the 3D content or the stereoscopic camera.

7. The method of claim 6 wherein said motion is one or more of: global motion, local motion, direction of motion (x, y, z subcomponents), gradient of motion, gradient of depth changes (z).

8. The method of claim 1 wherein said stereoscopic parameters are movements towards or away from the stereoscopic camera in the respective optical axis of one or more objects in the scene.

9. The method of claim 8 wherein said movements towards or away from the camera are detected by analyzing the rate of change in the depth map within consecutive frames of said two perspective data streams of a scene.

10. The method of claim 1 wherein said stereoscopic parameters are lack of synchronization between the left and right streams.

11. The method of claim 1 wherein said stereoscopic parameters are lack of calibration between the two cameras.

12. The device of claim 5 wherein the display is a virtual reality (VR) headset display or augmented reality (AR) display.

13. The device of claim 1 wherein said information is displayed in real time.

14. A device connectable to a portable computing platform having a processor, the device comprising:
a stereoscopic camera comprising two cameras, the two cameras located at a distance from one another, wherein the stereoscopic camera is configured to provide a three dimensional (3D) content having two perspective data streams of a scene, and wherein the processor is configured to:
provide a depth map of said scene based on the two perspective data streams;
analyze the two perspective data streams based on predefined stereoscopic discomfort data rules and the depth map to yield one or more stereoscopic parameters;
measure/process said stereoscopic parameters;
identify one or more stereoscopic effects based on said processed parameters.

15. The device of claim 14 wherein the processor is configured to:
assign weight for said one or more stereoscopic effects of said two perspective data streams according to the measured stereoscopic parameters; and
sum the weighted one or more stereoscopic effects to generate information of the impact of said one or more stereoscopic effects on a viewer of said 3D content.

16. The device of claim 15 wherein the weight of said one or more stereoscopic effects are measured as a function of time or frame for the complete 3D content.

17. The device of claim 14 wherein said stereoscopic parameters are one or more of a motion or speed of one or more objects in the 3D content or the stereoscopic camera.

18. The device of claim 17 wherein said motion is one or more of: global motion; local motion; direction of motion (x, y, z subcomponents); gradient of motion; gradient of depth changes (z).

19. The device of claim 14 wherein said stereoscopic parameters are movements towards or away from the stereoscopic camera in the respective optical axis of one or more objects in the scene.

20. A machine-readable non-transitory medium encoded with executable instructions for identifying and grading one or more stereoscopic effects in a captured stereoscopic image or video, the instructions comprising code for:
providing a depth map of said scene based on the two perspective data streams;
analyzing the two perspective data streams based on predefined stereoscopic discomfort data and the depth map to yield one or more stereoscopic parameters;
measure said stereoscopic parameters;
assign weight for the one or more stereoscopic effects of said two perspective data streams of a scene according to the measured stereoscopic parameters;
sum the weighted one or more stereoscopic effects to generate information of the impact of said one or more stereoscopic effects on a viewer of said 3D content.
